(19) United States
(12) Patent Application Publication
(10) Pub. No.: US 2016/0047052 A1
(43) Pub. Date: Feb. 18, 2016

(54) GAS DYNAMIC COLD SPRAY METHOD AND APPARATUS

(71) Applicants: VIACHESLAV E. BARANOVSKI, MAIDENS, VA (US); ANDREW V. BARANOVSKI, SANDY HOOK, VA (US)

(72) Inventors: VIACHESLAV E. BARANOVSKI, MAIDENS, VA (US); ANDREW V. BARANOVSKI, SANDY HOOK, VA (US)

(21) Appl. No.: 14/461,380

(22) Filed: Aug. 16, 2014

(51) Int. Cl. C23C 24/04; B05B 1/00; C23C 24/08

(52) U.S. Cl. CPC C23C 24/04; C23C 24/08; B05B 1/00

(57) ABSTRACT

A gas dynamic cold spray gun comprises a gun housing, a permeable body arranged inside the gun housing having a carrier gas inlet at a first end and a carrier gas outlet at a second end, an induction coil surrounding the permeable body and connected to a power supply, a nozzle affixed to the carrier gas outlet of the permeable body, and an orifice located downstream of the nozzle connected to a powder feeder.

### FIELD OF THE INVENTION

This application relates to the field of gas dynamic cold spray methods and apparatuses. More particularly, the application relates to a gas dynamic cold spray or cold spray gun and gas heater for use therewith.

### BACKGROUND

Gas dynamic cold spray method and guns are being developed to widen their application, reduce the cost of using cold spray technology and improve coating quality. Low-pressure cold spray systems utilize carrier gas pressures supplied to the gun at typically in the range of 8-15 bar (150 pounds per square inch (psi)), while high-pressure systems use carrier gas pressures of up to 35-60 bar (500-870 psi). The carrier gas is usually air or nitrogen (for low-pressure systems), or helium (for high pressure systems). Helium allows for higher jet stream velocities. For example, if gas is supplied into the nozzle under pressure of 40 bar and it is heated up to 1,000° C., helium stream velocity is about 3,150 meters per second (m/s), while air or nitrogen jet streams have a velocity of only 1,240 m/s under the same conditions. Correspondingly, powder particles' velocities are higher when sprayed with helium, so formed coatings are of better quality compared to those sprayed with air or nitrogen. The carrier gas passes through an electrical heater assembly, which heats the carrier gas before entering convergent-divergent nozzle, which, in turn, increases jet velocity and temperature. The heated gas then flows through a convergent-divergent nozzle and is accelerated. Powdered material is then introduced into the gas jet and is expelled at a supersonic velocity towards a substrate. The powdered material typically includes a single constituent metal, alloy, carbide, abrasive or a blend of such materials. The powdered material can be used to prepare (clean and abrade) the surface or deposit a coating onto the substrate.

There has been a tendency over past years to increase carrier gas temperature in gas dynamic cold spray guns. Higher carrier gas temperature allows for higher powder particle velocity and temperature, which improves quality of coatings, especially if spraying such hard-to-spray but important for industry materials as titanium, tantalum, hard alloys and cemented carbides. However, higher carrier gas temperatures require more powerful heaters, so prior art cold spray guns are rather heavy and at the same time the operating temperature range that they can provide is only 400-650° C., in some instances up to 1000° C. Moreover, packaging the cold spray gun components in a portable size that is also durable can be difficult. For example, the heater assembly in some cold spray guns is susceptible to breakage and electrical shorts due to rough handling. Furthermore, uneven cooling of serpentine path by carrier gas leads to arising of hot spots that locally overheat a serpentine element and eventually break it. Other heater assemblies, which are rather heavy and not adapted to cold spray technology, generate heat in such way that would expose the user to very high temperatures.

What is needed is a gas dynamic cold spray unit that can provide very high temperature of carrier gas in small volume, is durable, and does not expose a user to high temperature.

### BRIEF SUMMARY OF THE INVENTION

Embodiments of the invention provide a gas dynamic cold spray gun comprising an induction coil which is connected to a power supply and which surrounds a permeable body through which carrier gas is passed into an affixed nozzle and discharged through said nozzle forming a jet stream, and further comprising a downstream orifice connected to a powder feeder through which powder material is introduced into the jet stream. Embodiments of the invention provide a gas dynamic cold spray method comprising heating a permeable body by an induction coil, supplying carrier gas through the permeable body into a nozzle, discharging the carrier gas through the nozzle forming a jet stream, and introducing powder into said jet stream to form a coating on a substrate located downstream of the jet.

In one embodiment of the invention, a gas dynamic cold spray gun comprises a gun housing, a permeable body arranged inside the gun housing having a carrier gas inlet at a first end and a carrier gas outlet at a second end, an induction coil surrounding the permeable body and connected to a power supply, a nozzle affixed to the carrier gas outlet of the permeable body, and an orifice located downstream of the nozzle connected to a powder feeder.

In addition to the gas dynamic cold spray gun as described above, other aspects of the present invention are directed to corresponding methods for gas dynamic cold spray coating deposition.

### BRIEF DESCRIPTION OF THE SEVERAL VIEWS OF THE DRAWING(S)

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a schematic perspective view of a gas dynamic cold spray unit, in accordance with embodiments of the invention.

FIG. 2 is a broken cross-sectional view of an example cold spray gun of the gas dynamic cold spray unit of FIG. 1, with an induction coil surrounding a permeable body.

FIG. 3 is a detailed view of the cold spray gun nozzle assembly of the cold spray gun of FIG. 2.

FIG. 4 is a cross-sectional view of an example permeable body taken along line C-C in FIG. 6.

FIG. 5 is a side elevational view of the example permeable body shown in FIG. 4.

FIG. 6 is an end view of the example permeable body shown in FIGS. 4 and 5.

FIG. 7 is a cross-sectional view of the example permeable body shown in FIGS. 4 and 5 taken along line B-B in FIG. 5.

FIG. 8 is a cross-sectional view of another example permeable body taken along line D-D in FIG. 9.

FIG. 9 is a side elevational view of the example permeable body shown in FIG. 8.

FIG. 10 is an end view of the example permeable body shown in FIGS. 8 and 9.

FIG. 11 is a broken cross-sectional view of an example cold spray gun of a gas dynamic cold spray unit, with an induction coil surrounding a one piece permeable body-nozzle, in accordance with alternative embodiments of the invention.

FIG. 12 is a detailed view of the cold spray gun nozzle throat portion of the one piece permeable body-nozzle of FIG. 11.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, or brief summary, or in the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

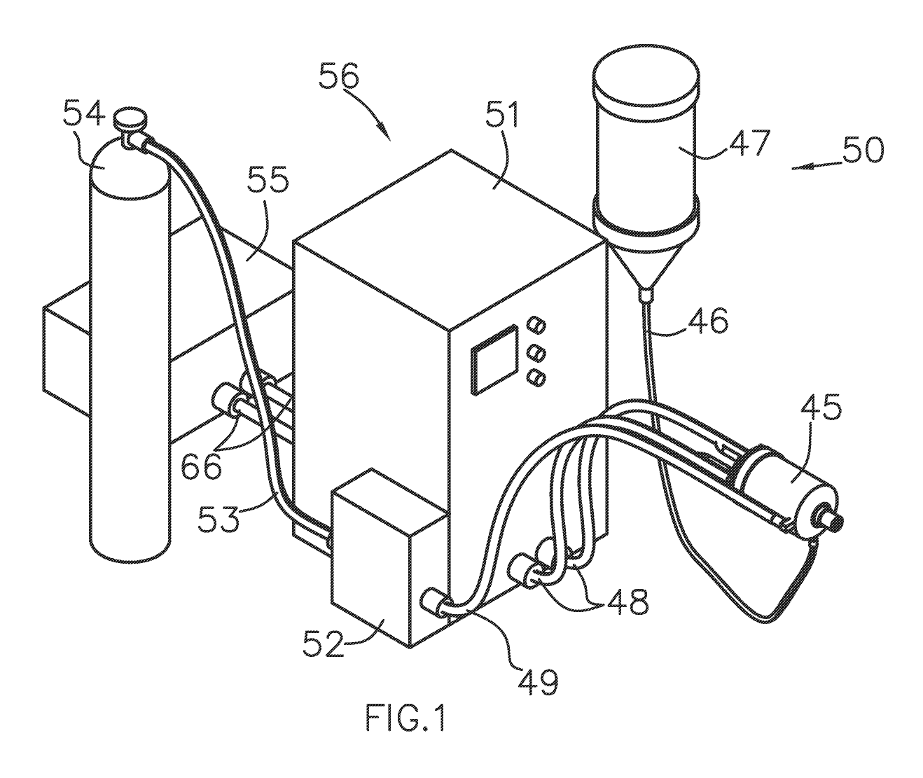

A cold spray unit 56 is shown in FIG. 1, in accordance with embodiments of the invention. The unit 56 includes a control unit 52 connected to a power supply (not shown) and a gas source 54 via a gas supply hose 53. The unit 56 also includes induction heater power supply unit 51 that is connected to the water cooling unit 55 via hoses 66, which supplies cooling water to both unit 51 and a spray gun 45. Induction heater power supply unit 51 provides alternating electrical current to the induction coil 16 located in the spray gun 45 through two special hoses 48 that contain copper power leads inside. Carrier gas, such as helium, air, nitrogen, argon, hydrogen, or a mixture of gases, from the control unit 52 is supplied to the gun through a hose 49. The control unit 52 controls and monitors the various inputs and outputs of the unit 56 to obtain desired deposition of powder material onto the substrate. For example, the control unit 56 monitors and controls such process parameters as gas pressure, gas flow rate, temperature of the permeable body 17, flow of powder through the gun, operational sequence of the system, etc.

A powder feeder 50 having one or more powder containers 47 supplies powder material to the spray gun 45 for deposition onto a substrate. Example powder materials include metal, ceramic, metal alloy, cemented carbides, etc. The powdered material is supplied to the spray gun 45, through power hose 46, at the times and rates that are set up by the operator using control unit 52. The powder container 47 is designed to withstand back pressure from the spray gun.

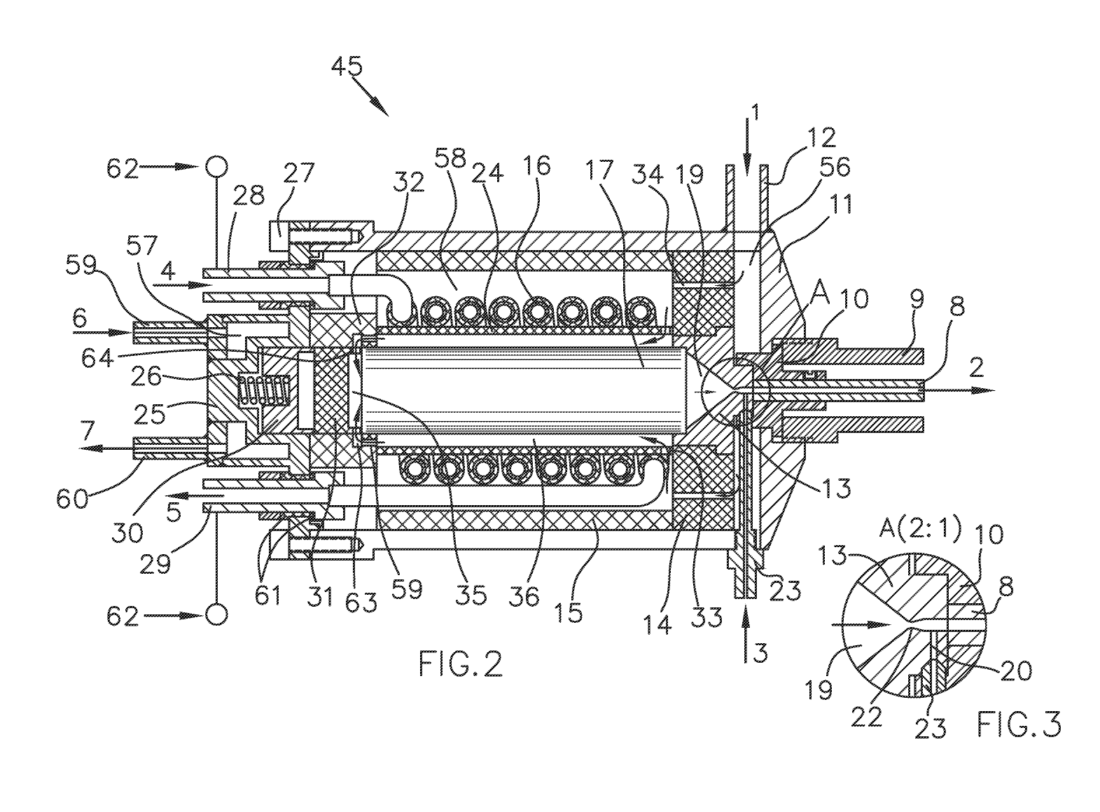

The spray gun 45 is shown in more detail in FIG. 2 and FIG. 3 (FIG. 3 is a 2:1 enlargement of area A of FIG. 2). The spray gun 45 includes a gun housing 11. The front portion of the gun housing 11 accommodates an outlet fitting 10 secured to the housing 11 by retaining nut 9. The outlet fitting 10 receives a nozzle 13 that provides a convergent-divergent orifice for accelerating the carrier gas. The nozzle 13 includes a throat 22. In one example, a converging section is provided upstream from the throat 22, and a diverging section is provided downstream from the throat 22. In one example, a powder feed passage 20 is provided in the nozzle 13 downstream from the throat 22 for introducing powder material (illustrated by arrow 3) provided through a powder injector 23, further connected to the powder feeder 50 through a powder hose 46. A tube 8 is received in an end of the nozzle 13, and the tube 8 deposits the supersonic powder material indicated by arrow 2 on a substrate (not shown). While many different materials can be used for the nozzle 13, depending on design temperature of the permeable body 17, for achieving highest possible temperature it is desirable to make nozzle 13 from a material with suitably high melting point and suitably low thermal and electrical conductivities. Low thermal conductivity of the material of the nozzle 13 helps to contain heat in the carrier gas in the converging portion 19 of the nozzle. Low electrical conductivity of the nozzle 13 prevents the nozzle 13 from the undesirable overheating caused by induction coil 16. It is preferable to use hafnium carbide (HfC) or tantalum carbide (TaC) that have suitably high melting points (3,900° C. and 3,880° C. respectively), but low thermal (30 W·m⁻¹·K⁻¹ and 21 W·m⁻¹·K⁻¹ respectively) and electrical (37 μΩ·cm and 25 μΩ·cm respectively) conductivities. Nozzle 13 can be composite, comprising two or more parts, with each part made of a different material that better suits the operating conditions of that portion of the nozzle.

A permeable body 17 is arranged within the gun housing 11 to rapidly heat the carrier gas and reduce its density. The distal end of permeable body 17 is received by the convergent portion 19 of the nozzle 13. The heat within the permeable body 17 is generated by water cooled induction coil 16 that is arranged within inner chamber 58 in such manner that induction coil 16 envelops the permeable body 17. In one example, the permeable body 17 is suspended in the housing 11 by a front support 14 and a rear support 32. Front and rear supports 14 and 32 reduce heat transfer from permeable body 17 to the housing 11. Any high-melting point material with low thermal and electrical conductivities can be used for front and rear supports 14 and 32; however it is preferable to use hafnium carbide (HfC) or tantalum carbide (TaC). Low electrical conductivities of HfC and TaC significantly reduce undesirable heating of the front support 14 and the rear support 32 by the induction coil 16, while low thermal conductivity significantly reduces amount of heat transferred to the gun housing 11.

The housing 11 and the induction coil 16 are shielded from radiation heat generated by permeable body 17 by insulating bushings 24 and 15 that can be made from a refractory material, in one example, tantalum carbide or hafnium carbide. Bushing 24 is cylindrical and surrounds, but does not contact, permeable body 17. Bushing 15 is cylindrical and surrounds, but does not contact, induction coil 16, bushing 24, and permeable body 17. The gun housing 11 and the front support 14 form a front chamber 56 that receives carrier gas indicated by arrow 1 through the inlet fitting 12. The front support 14 has a row of circumferential orifices 34 (two of which are seen in FIG. 2) connecting front chamber 56 with outer chamber 58, formed by insulation bushings 15 and 24. A row of circumferential orifices 33 (two of which are seen in FIG. 2) provide a passage for carrier gas flowing from the outer chamber 58 into the inner chamber 36. The rear support 32 has a row of circumferential orifices 59 (two of which are seen in FIG. 2) exiting into the undercut 63 that, along with a row of circumferential orifices 64 (two of which are seen in FIG. 2) in the insulating bushing 31, form a passage for carrier gas from the inner chamber 36 into the rear chamber 35.

In one example, a permeable body 17 is biased forward by biasing member 26 (which may be, for example, a spring) arranged between a cup 30 and a rear water cooled flange 25 that is secured to the gun housing 11 with bolts 27 (two of which are seen in FIG. 2). Insulating bushing 31, made from a refractory material and freely installed between the cup 30 and the permeable body 17, shields rear flange assembly 25 from the heat radiated by the permeable body 17. The insulating bushing 32 has a recess on the end facing permeable body 17 that defines rear chamber 35. The rear flange 25 has an inner passage 57 and two nipples 59 and 60 that receive and return cooling water, indicated respectively by arrows 6 and 7, from/to the power supply unit 51.

The ends of induction coil 16 have fittings 28 and 29 that are passing through two holes in the rear flange 25, in the example shown, and are electrically insulated from the gun housing 11 by two insulating bushings 61. The fittings 28 and 29 respectively receive and return cooling water, as indicated respectively by arrows 4 and 5, and alternating electrical current, as schematically indicated by arrows 62, from the power supply unit 51 through two special hoses 48. The power supply unit 51 provides electrical current with a typical frequency of 50 Hz to 200 kHz. The use of electromagnetic fields generated by lower frequencies (under 10 kHz) is preferable as lower frequency electromagnetic fields are more effective at penetrating electrically conductive materials. Since the current supplied to the induction coil 16 can exceed 1000 A, typically water cooling is used.

The permeable body 17 can be made from any electrically conductive, material, depending on required maximal carrier gas temperature and requirements to the spray gun weight and dimensions. In order to achieve the maximal possible carrier gas temperature, the preferred material is tungsten, having a melting point of 3,422° C. and high thermal conductivity of 173 W·m⁻¹·K⁻¹, which facilitates effective transfer of heat to the carrier gas. For weight reduction purposes, graphite can be used, which has a sublimation point of 3,642° C. The permeable body 17 can have any outer geometrical shape, in one example it can be a cylindrical shape. The permeable body 17 can have any internal design. The permeable body 17 has a plurality of holes, channels, or voids to permit the flow of carrier gas from rear chamber 35 to the nozzle 13. It is these holes, channels, or voids that provide permeability to the permeable body 17; the remainder of the permeable body 17 is, in fact, impermeable. The internal design of the permeable body 17 should provide its effective heating by the induction coil 16, as well as it should provide the most effective transfer of heat from the material of the permeable body 17 to the carrier gas flowing through the voids in the permeable body 17.

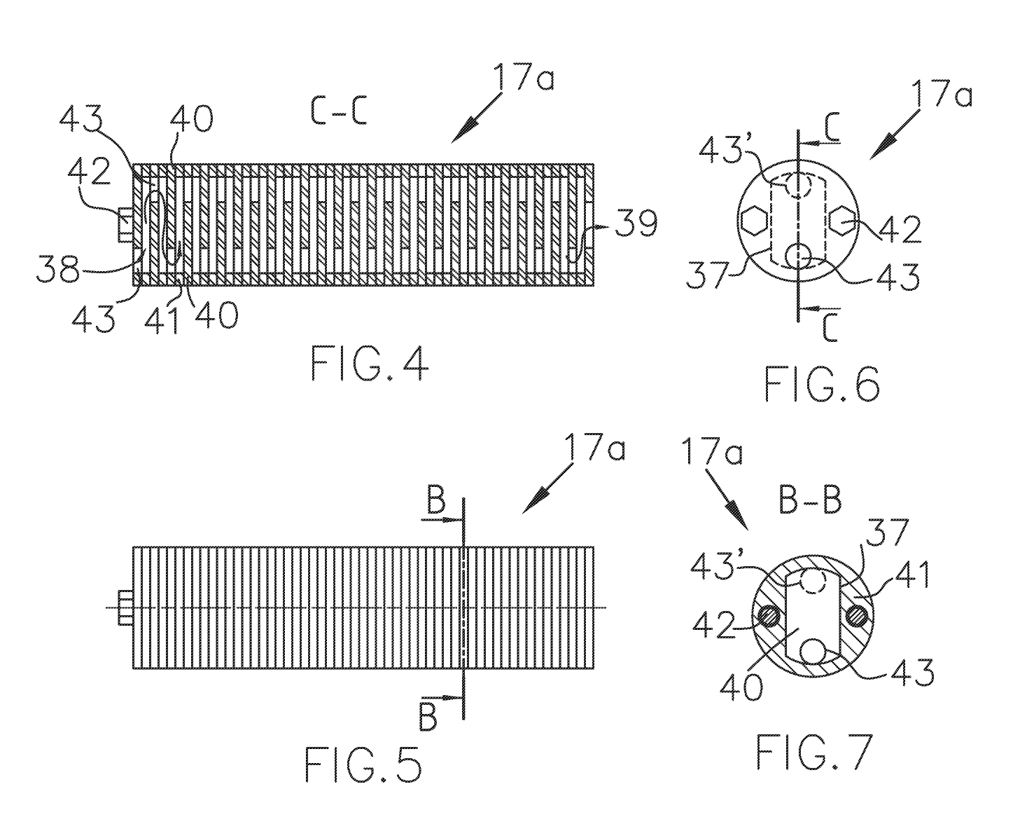

Referring to FIG. 4, FIG. 5, FIG. 6 and FIG. 7, in one example of an embodiment of the invention, the permeable body 17a can be made from a stack of tungsten discs 40 and 41 joined together by two or more tungsten bolts 42. Each disc 40 has an opening 43 for carrier gas passage, indicated by arrow 38, and each consequent disc 40 is installed with 180° turn relative to the previous one of disc 40. The discs 41 are installed between the discs 40 and they each have an opening 37 that overlaps openings 43, which provides a passage for the carrier gas from the opening 43 in one disc 40 to the opening 43 in the next disc 40. In FIG. 7, disc 40 that is immediately behind disc 41 can be seen through opening 37 in disc 41. Additionally, the opening in the next instance of disc 40 (which is not visible in FIG. 7) is illustrated in dashed line and labeled 43′. For the disc through which the carrier gas exits the permeable body 17a (i.e., the distal end disc that would be adjacent the nozzle 13), the opening in that disc would be in the center of the disc (as shown in FIG. 4), rather than offset, to enable the exiting carrier gas to enter the center of the nozzle 13. On the one hand, such a design provides a very large area of contact between the passing carrier gas and the material of the permeable body 17a, and multiple serpentine turns create highly turbulent flow of the carrier gas further improving heat exchange. On the other hand, such a design also provides effective heating of the permeable body 17a by the induction coil 16, since the electromagnetic field generated by the induction coil 16 induces a circular eddy current in the plane that is perpendicular to the axis of an induction coil.

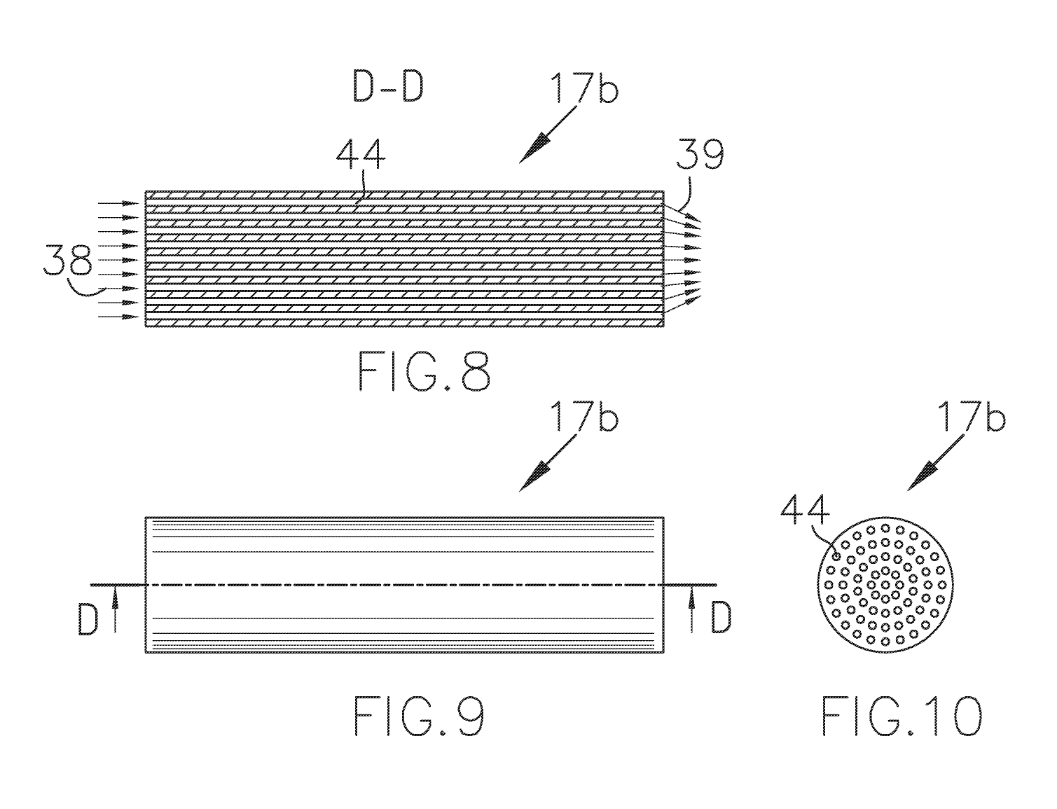

Referring to FIG. 8, FIG. 9 and FIG. 10, in another example of an embodiment of the invention, the permeable body 17b is made from a single solid piece of tungsten with multiple circumferential holes 44 machined along its axis. Each hole 44 penetrates through the entire length of the permeable body 17b.

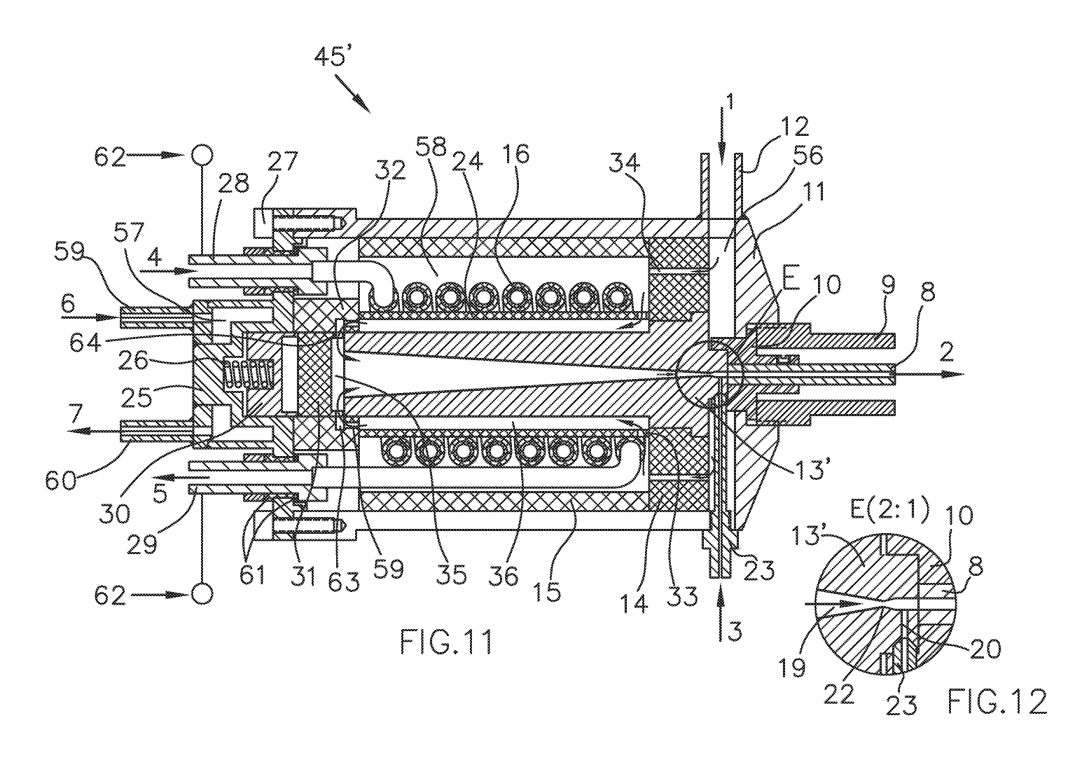

Referring to FIG. 11 and FIG. 12, in another example of an embodiment of the invention, spray gun 45′ comprises a permeable body and nozzle which are made from one piece of material forming a single dual-function part, a permeable body-nozzle 13′. In all other respects, the structure and function of the spray gun 45′ of FIG. 11 is the same as spray gun 45 of FIG. 2. The advantage conferred is a simplified and less expensive design of the spray gun 45.

Referring again to FIG. 2, in one example, the carrier gas supplied through the fitting 12 into the front chamber 56 cools down the front portion of the gun and then flows through the orifices 34 into the outer chamber 58 and further into the inner chamber 36 through the orifices 33. Flowing along the inner chamber 36 the carrier gas is being heated by the outer surface of the permeable body 17. This first pass of carrier gas also acts to insulate the heated outer surface of the permeable body 17 and minimize heat transfer to the gun housing 11. The carrier gas flows through the orifices 59 and 64 into the rear chamber 35 and further through the multiple passages in the permeable body 17 where the carrier gas is rapidly heated by heat exchange with material of the permeable body 17. The temperature of the carrier gas is determined by the size and temperature of the permeable body 17, carrier gas flow, as well as by quantity and size of the passages in the permeable body 17. Additional or fewer passages can be provided to obtain desired heating of the carrier gas within the permeable body 17. The temperature of the permeable body is adjusted automatically by changing power of the power supply unit 51 using feedback received from an infrared temperature sensor installed in the gun (not shown).

The heated carrier gas 39 (shown in FIG. 4 and FIG. 8) flows from the outlet end of the permeable body 17 into the convergent portion of the nozzle 13, and further through the throat 22 into the divergent portion of the nozzle 13 where it accelerates to supersonic velocity, picks up powder supplied via powder feed passage 20 and applies it onto the substrate forming high quality coating.

Embodiments of the invention are illustrated herein and described above as having a single permeable body surrounded by a single induction coil to provide heated carrier gas to a nozzle. In alternative embodiments of the invention, two or more separate permeable bodies, each surrounded by a separate induction coil, may provide heated carrier gas to a single nozzle.

Embodiments of the invention are illustrated herein and described above as having a convergent-divergent nozzle. In alternative embodiments of the invention, other suitable types of nozzles may be used, such as a convergent nozzle, a divergent nozzle, a cylindrical nozzle, or a flat nozzle.

Compared to the prior art, the proposed method and apparatus enable three fold higher carrier gas temperature, in excess of 3,000° C. As a result, the jet stream velocity at the convergent-divergent nozzle outlet can exceed 5,370 m/s at 40 bar pressure, when using helium as a carrier gas, compared to 3,100 m/s using the prior art. Correspondingly, powder particles have higher kinetic energy when exiting the apparatus which significantly improves coating quality. At the same time, higher carrier gas temperature lowers carrier gas density that in turn allows lowering helium consumption by 41-43% when spraying, which is extremely important for the industry, taking into account very high cost of helium.

Another benefit of higher carrier gas temperature is that other cheaper gases, such as nitrogen or argon, can be used for getting high quality coatings, since being heated above 3,000° C. at 40 bar pressure they provide jet stream velocities of 2,100 m/s and 1670 m/s, respectively, compared to 1200 m/s and 970 m/s using the prior art. The method and apparatus of embodiments of the invention can achieve practically the same gas velocity and coating quality using low cost gases, as the prior art could achieve only with expensive gases such as helium.

Although example embodiments have been disclosed, a person of ordinary skill in this art would recognize that certain modifications would come within the scope of the claims. For that reason, the following claims should be studied to determine their true scope and content.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A gas dynamic cold spray gun comprising:
a gun housing;
a permeable body arranged inside the gun housing having a carrier gas inlet at a first end, and a carrier gas outlet at a second end;
an induction coil surrounding the permeable body and connected to a power supply;
a nozzle affixed to the carrier gas outlet of the permeable body; and
an orifice located downstream of the nozzle connected to a powder feeder.

2. The gas dynamic cold spray gun of claim 1, where the permeable body comprises an electrically conductive material.

3. The gas dynamic cold spray gun of claim 1, where the permeable body comprises Tungsten or Tungsten alloys.

4. The gas dynamic cold spray gun of claim 1, where the permeable body comprises Graphite.

5. The gas dynamic cold spray gun of claim 1, where the permeable body comprises Tantalum Carbide.

6. The gas dynamic cold spray gun of claim 1, where the permeable body comprises Hafnium Carbide.

7. The gas dynamic cold spray gun of claim 1, where the permeable body comprises Zirconium Carbide.

8. The gas dynamic cold spray gun of claim 1, where the permeable body comprises a plurality of inputs for carrier gas.

9. The gas dynamic cold spray gun of claim 1, where the permeable body comprises a plurality of outputs for carrier gas.

10. The gas dynamic cold spray gun of claim 1, where the permeable body comprises a plurality of individually connected bodies of any shape or geometry.

11. The gas dynamic cold spray gun of claim 1, further comprising one or more additional permeable bodies and one or more additional induction coils, where each additional one of the permeable bodies is surrounded by a corresponding additional one of the induction coils, and where all of the permeable bodies converge to the nozzle.

12. The gas dynamic cold spray gun of claim 1, where the nozzle comprises Tungsten or Tungsten alloys.

13. The gas dynamic cold spray gun of claim 1, where the nozzle comprises Graphite.

14. The gas dynamic cold spray gun of claim 1, where the nozzle comprises Tantalum Carbide.

15. The gas dynamic cold spray gun of claim 1, where the nozzle comprises Hafnium Carbide.

16. The gas dynamic cold spray gun of claim 1, where the nozzle comprises Zirconium Carbide.

17. The gas dynamic cold spray gun of claim 1, further comprising at least one additional orifice located downstream of the nozzle connected to the powder feeder or to a corresponding additional powder feeder.

18. The gas dynamic cold spray gun of claim 1, where the permeable body and the nozzle together comprise a single unitary structure.

19. The gas dynamic cold spray gun of claim 1, where the nozzle comprises a convergent-divergent nozzle.

20. The gas dynamic cold spray gun of claim 1, where the nozzle comprises a divergent nozzle.

21. The gas dynamic cold spray gun of claim 1, where the nozzle comprises a convergent nozzle.

22. The gas dynamic cold spray gun of claim 1, where the nozzle comprises a cylindrical nozzle.

23. The gas dynamic cold spray gun of claim 1, where the nozzle comprises a flat nozzle.

24. The gas dynamic cold spray gun of claim 1, where the nozzle comprises a composite nozzle.

25. A gas dynamic cold spray coating deposition method comprising:
supplying an electrical current to an induction coil which surrounds a permeable body of a gas dynamic cold spray gun, the electrical current having a frequency sufficient to generate an electromagnetic field around the permeable body and induce eddy currents in said permeable body to heat the permeable body to a desired temperature;
supplying carrier gas to the permeable body;
discharging carrier gas through a carrier gas outlet of the permeable body into a convergent-divergent nozzle;
discharging carrier gas through a nozzle, forming a high-velocity jet stream;
supplying powder into said jet stream through a downstream orifice connected to a powder feeder; and
directing the jet stream with accelerated powder toward a substrate.

26. The gas dynamic cold spray coating deposition method of claim 25, where the supplied carrier gas comprises nitrogen.

27. The gas dynamic cold spray coating deposition method of claim 25, where the supplied carrier gas comprises argon.

28. The gas dynamic cold spray coating deposition method of claim 25, where the supplied carrier gas comprises helium.

29. The gas dynamic cold spray coating deposition method of claim 25, where the supplied carrier gas comprises air.

30. The gas dynamic cold spray coating deposition method of claim 25, where the supplied carrier gas comprises hydrogen.

31. The gas dynamic cold spray coating deposition method of claim 25, where the supplied carrier gas comprises a mixture of gases.

32. The gas dynamic cold spray coating deposition method of claim 25, where the permeable body and the nozzle together comprise a single unitary structure.

33. The gas dynamic cold spray coating deposition method of claim 25, where the nozzle comprises a convergent-divergent nozzle.

34. The gas dynamic cold spray coating deposition method of claim 25, where the nozzle comprises a divergent nozzle.

35. The gas dynamic cold spray coating deposition method of claim 25, where the nozzle comprises a convergent nozzle.

36. The gas dynamic cold spray coating deposition method of claim 25, where the nozzle comprises a cylindrical nozzle.

37. The gas dynamic cold spray coating deposition method of claim 25, where the nozzle comprises a flat nozzle.

38. The gas dynamic cold spray coating deposition method of claim 25, where the nozzle comprises a composite nozzle.
